(19) United States
(12) Patent Application Publication
(10) Pub. No.: US 2006/0252488 A1
(43) Pub. Date: Nov. 9, 2006

(54) Lottery gaming method and apparatus

(76) Inventors: Marie-Claudel Lalonde, Montreal (CA); Claire Arcand, Quebec (CA); Danielle Dumouchel, Quebec (CA)

Correspondence Address: BANNER & WITCOFF, 1001 G STREET N W, SUITE 1100, WASHINGTON, DC, 20001, US

(21) Appl. No.: 10/547,372

(22) PCT Filed: Mar. 1, 2004
(86) PCT No.: PCT/CA04/00277

§ 371 Date: Jun. 1, 2006

(30) Foreign Application Priority Data
Feb. 28, 2003 (US) 60450352

(51) Int. Cl. A63F 13/00

(52) U.S. Cl. 463/17

(57) ABSTRACT

The present invention provides a lottery type game for play on a game medium wherein the lottery type game comprises a primary game area having therein a plurality of target symbols and a secondary game area having a plurality game symbols therein. The game symbols are positioned in one or more arrangements within the secondary game area. During play of the game, target symbols are used to reveal game symbols within the one or more arrangements through actions including matching of target and game symbols. Prior to play of the lottery type game at least one of the primary game area or the secondary game area is concealed from the view of the player, wherein during play of the game some or all of the concealed symbols are revealed. Prize determining means are associated with the game medium, wherein a predetermined prize is associated with each arrangement of game symbols. A prize associated with a particular arrangement of game symbols is won when all of the game symbols associated with the particular arrangement are revealed during play of the game. The winning of a lottery type game according to the present invention may not be accomplished solely by matching target symbols with game symbols, an additional action or revealed game symbol can typically be required in order to reveal a complete arrangement of game symbols. This additional action or game symbol identification can provide a player with an additional incentive to play the game, since by just revealing the target symbols one is typically unable to determine if a prize is won.

### FIELD OF THE INVENTION

The present invention pertains to the field of games and more particularly to the field of lottery type games.

### BACKGROUND

In the past, lottery games were introduced in which players could purchase tickets for which the results could instantly be determined. These games generally included a scratch-off ticket (or game piece) where a number of items were to be matched according to a predetermined winning scheme. These types of games are often played for entertainment purposes and are often run by government agencies in order to raise revenue. These types of games are most often games of chance where a player purchases a ticket valid for one or more plays of the game, wherein this ticket provides an opportunity to win a pool of money or some other valuable prize.

There are two kinds of scratch-off games, deterministic and probabilistic. An example of predetermined (or deterministic) play is a ticket having one or more covered playing areas which can be revealed by removing rub and reveal material, for example aluminium permeated latex. When the playing areas are uncovered, the information printed on the ticket completely determines whether the ticket is a winning ticket. When the tickets are printed, the sponsor predetermines the number of winners by controlling the number of winning tickets printed. The disadvantage of deterministic games is that most tickets are non-winning and, therefore, the player feels he or she has little or no control over the game.

On the other hand, an example of a probability game is a game piece having three sections, each having two covered playing areas where a winning symbol is present in only one of the playing areas in each section. To win, the winning symbols must be the only symbols revealed. The sponsor, therefore, depends upon probability distribution to control the prize allocation, since potentially, each ticket is a winner. The problem with probability games is that the game can often be “cracked” or a larger than expected number of people could be lucky. In either case, the sponsor could potentially lose money. Also, significant validation problems exist with probability games. For instance, in order to validate such tickets, the validator must know which boxes have been scratched off from a particular ticket.

In the prior art there are a number of “scratch and win” lottery type tickets that are associated with words or scrambled words. For example, there is the “Wheel of Fortune” scratch ticket offered by the Michigan Lottery, the “Jumble” scratch ticket produced by Frost Productions and the “Operation” scratch ticket available in Australia. Each of these tickets comprise a first game area having a plurality of concealed letters that are revealed by a player, and the player subsequently attempts to correlate these revealed letters with letters in scrambled or unscrambled words in a second game area If all of the letters within one of the scrambled or unscrambled words are correlated with the letters in the first game area, the player wins the prize associated with that particular matched word.

Furthermore, U.S. Pat. No. 6,241,246 discloses a lottery ticket having a first game area with a grid of target letters arranged so that at least some of the letters form target words and a second game area having a list of pre-selected game words which are covered by a scratch-off layer. The game words are matched with the target words to determine if a prize has been won. The winning structure is based on the number of game words that match target words found in the first area.

U.S. Pat. No. 5,657,991 discloses a scratch of ticket that relates to a game method for bingo-like games. The game can be played on different formats, namely a scratch-off game card, a pull-tab type card or a video display terminal. The two games disclosed in the patent are Bingo and Keno and in each case a primary game area and one or several secondary game areas are present. The primary area contains a number of hidden predetermined numbers that the player reveals and matches with numbers contained in the secondary area(s).

Additionally, U.S. Pat. No. 5,451,052 discloses a game piece and a method of simulating a player selection lottery game using the game piece. The game piece has a primary game area that contains target number combinations, for example 3 or 4 digit numbers. It has secondary game areas having different matching structures for matching with target number combinations from the primary game area. The game described also has, for each matching structure, a predetermined prize indicia. The relevant match types include a potential “exact order” match to a secondary playing area, an “any order” match to a secondary playing area, a “plurality” match to a secondary playing area, and a “single digit” match to a secondary playing area. If the criteria of the match type are met, the game piece is redeemable for the prize indicated in the associated predetermined prize indicia.

Each of the above games provide a scratch of type game that involves the revealing of a predetermined number of letters and then determining if these letters provide one with the ability to spell any of the words associated with a prize. As such once the letter have been revealed the winning or losing of the game is immediately determined. Therefore there is a need for a lottery type game wherein upon the revealing of a predetermined number of first symbols, a player must continue to play the game in order to determine if they win prize, thereby resulting in a player interacting with the lottery type game for an extended period of time potentially increasing a players enjoyment of the lottery type game.

This background information is provided for the purpose of making known information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide a lottery gaming method and apparatus. In accordance with an aspect of the present invention, there is provided a method of playing a lottery type game comprising the steps of: providing a game medium including: a primary game area on said game medium, said primary game area having a plurality of target symbols therein, said target symbols being concealed from a player prior to play of the lottery type game; a secondary game area on said game medium, said secondary game area comprising one or more arrangements of game symbols, a predetermined number of the game symbols corresponding to target symbols; and a prize determining means on said game medium, said prize determining means enabling a player to determine if the player has won a prize after play of the lottery type game; revealing said target symbols; matching and revealing game symbols in said secondary game area using said target symbols; determining if an entire arrangement of game symbols in the secondary game area is matched or revealed using the target symbols; and awarding the player the prize associated with a particular arrangement of game symbols if the entire arrangement of game symbols is matched or revealed.

In accordance with another aspect of the invention, there is provided a lottery type game apparatus enabling play of a lottery type game, said apparatus having displayed thereon: a primary game area having a plurality of target symbols therein, said primary game area being concealed from a player prior to play of the lottery type game; a secondary game area comprising one or more arrangements of game symbols, a predetermined number of the game symbols corresponding to target symbols, a prize determining means for determining a prize based on matching target symbols with game symbols, the prize corresponding to an arrangement of game symbols being awarded when an entire arrangement of game symbols in the secondary game area is matched or revealed using the target symbols.

In accordance with another aspect of the invention, there is provided a method of playing a lottery type game comprising the steps of: providing a game medium including: a primary game area on said game medium, said primary game area having a plurality of target symbols therein; a secondary game area on said game medium, said secondary game area comprising one or more arrangements of game symbols, a predetermined number of the game symbols corresponding to target symbols, wherein at least one of the primary game area and the secondary game area are concealed from a player prior to play of the lottery type game; and a prize determining means on said game medium, said prize determining means enabling a player to determine if the player has won a prize after play of the game; revealing target symbols and game symbols that are concealed; matching game symbols in said secondary game area using said target symbols; determining if an entire arrangement of game symbols in the secondary game area is matched or revealed using the target symbols; and awarding the player the prize associated with a particular arrangement of game symbols if the entire arrangement of game symbols is matched or revealed.

In accordance with another aspect of the invention, there is provided a computer program product comprising a computer readable medium having a computer program recorded thereon for performing a method of playing a lottery type game, said method comprising the steps of: providing a game medium including: a primary game area on said game medium, said primary game area having a plurality of target symbols therein, said target symbols being concealed from a player prior to play of the lottery type game; a secondary game area on said game medium, said secondary game area comprising one or more arrangements of game symbols, a predetermined number of the game symbols corresponding to target symbols; and a prize determining means on said game medium, said prize determining means enabling a player to determine if the player has won a prize after play of the game; revealing said target symbols; matching and revealing game symbols in said secondary game area using said target symbols; determining if an entire arrangement of game symbols in the secondary game area is matched or revealed using the target symbols; and awarding the player the prize associated with a particular arrangement of game symbols if the entire arrangement of game symbols is matched or revealed.

### BRIEF DESCRIPTION OF THE FIGURES

FIG. 1 is a schematic view of one embodiment of the present invention with a primary game area, a secondary game area and a prize determining means.

FIG. 2 is a schematic view of the embodiment according to FIG. 1 during a stage of play of the lottery type game.

FIG. 3 is a schematic view of another embodiment of the present invention with a primary game area, a secondary game area and a prize determining means.

FIG. 4 is a schematic view of the embodiment according to FIG. 3 during a stage of play of the lottery type game.

### DETAILED DESCRIPTION OF THE INVENTION

### DEFINITIONS

The term “symbol” is used to describe any distinguishable representation, which is positioned within a lottery game in a manner that it can be located and/or revealed by a player during play of the lottery game and may be, for example, but not limited to a picture of an object, letter or number or any other graphical representation as would be known to a worker skilled in the relevant art.

The term “target symbol” is used to describe a symbol that is located within the primary game area.

The term “game symbol” is used to describe a symbol that is located within the secondary game area

The term “gaming medium” is used to define a medium using which a lottery type game can be played. A gaming medium can be a printed medium, an electronic medium for example a computer or video lottery machine or any other medium, as would be readily understood by a worker skilled in the art.

The term “arrangement” is used to define a configuration of symbols wherein this configuration can be any shape and have one or more symbols therein. An arrangement can optionally appear to be a random configuration of symbols.

Unless defined otherwise, all technical and scientific terms used herein have the same meaning as commonly understood by one of ordinary skill in the art to which this invention belongs.

The present invention provides a lottery type game for play on a game medium wherein the lottery type game comprises a primary game area having therein a plurality of target symbols and a secondary game area having a plurality game symbols therein. The game symbols are positioned in one or more arrangements within the secondary game area. During play of the game, target symbols are used to reveal game symbols within the one or more arrangements through actions including matching of target and game symbols. Prior to play of the lottery type game at least one of the primary game area or the secondary game area is concealed from the view of the player, wherein during play of the game the concealed some or all of the concealed symbols are revealed. Prize determining means are associated with the game medium, wherein a predetermined prize is associated with each arrangement of game symbols. A prize associated with a particular arrangement of game symbols is won when all of the game symbols associated with the particular arrangement are revealed during play of the game. The winning of a lottery type game according to the present invention may not be accomplished solely by matching target symbols with game symbols, an additional action or revealed game symbol can typically be required in order to reveal a complete arrangement of game symbols. This additional action or game symbol identification can provide a player with an additional incentive to play the game, since by just revealing the target symbols one is typically unable to determine if a prize is won.

Primary Game Area

The primary game area comprises a plurality of target symbols therein. The target symbols can be arranged in an organised fashion for example in one or more rows and/or columns wherein each location in a row or column has a target symbol associated therewith. Alternately, the target symbols within the primary game area can be arranged in any other predetermined manner or optionally can be randomly positioned within the primary game area.

The target symbols within the primary game area can be either concealed from the view of a player or can alternately be visible to a player prior to play of the lottery type game. If the target symbols are concealed from the player, these symbols can be revealed during play of the lottery type game. If the target symbols are concealed from the view of the player, one or more symbols or a picture can be covering the primary game area prior to play of the lottery type game, wherein the one or more symbols or picture may have the location of the target symbols within the primary game area indicated thereon.

Secondary Game Area

The secondary game area comprises one or more arrangements of game symbols and a predetermined number of the game symbols correspond to the target symbols in the primary game area. The one or more arrangements of game symbols can be organised for example in one or more rows and/or columns wherein each location in a row or column has a game symbol associated therewith. Alternately, the one or more arrangements within the secondary game area can have any other predetermined configuration or optionally the game symbols within a particular arrangement can be randomly positioned therein.

In an alternate embodiment of the present invention, wherein the arrangements in the secondary game area are collection of rows and columns, each arrangement in the secondary game area can be dependent on another. For example, a portion of a row or column may intersect with another row or column from another arrangement resulting in a configuration similar to a crossword, however in this embodiment, the game symbols are not limited to letters only.

The target symbols within the primary game area can be either concealed from the view of a player or can alternately be exposed from the view of a player prior to play of the lottery type game. If the target symbols are concealed from the player, these symbols can be revealed during play of the lottery type game. In addition, some of the game symbols in the secondary game area can be concealed while other game symbols in the secondary game area may be visible to the player prior to play of the lottery type game.

Prize Determining Means

The prize determining means enables a player to determine if a prize is won upon the completion of the play of the lottery type game. The prize determining means comprises a prize indicator, for example a dollar value, a picture of the prize or other form of indicator, as would be readily understood by a worker skilled in the lottery game field. A prize indicator is associated with one or more of the arrangements, wherein when all of the game symbols within a particular arrangement having an associated prize indicator therewith, that associated prize indicator provides a means for determining what is won by the player.

The prize indicator can be visible or concealed from the player prior to play of the lottery type game, depending on the desire of the lottery type game operator. It would be readily understood that an indication of the potential prize may enhance the possibility that a player would decide to play a particular lottery type game.

The lottery type game according to the present invention will be further described with reference to the figures illustrating different embodiments of the present invention.

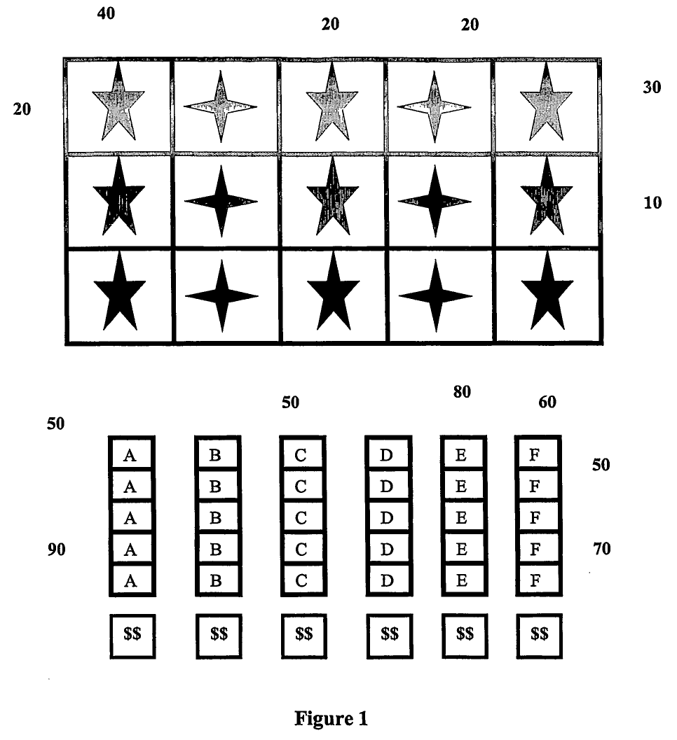

In one embodiment and with reference to FIG. 1, a lottery type game according to the present invention comprises a primary game area 10 including a plurality of locations 20 in a grid formation for example, in the form of a plurality of rows and columns wherein each location has a target symbol associated therewith. A worker skilled in the relevant art would understand that the primary game area may comprise various numbers of rows and columns of locations or the locations may be randomly positioned within the primary game area. In this embodiment, a concealing layer is associated with the target symbols in order to hide them from view of a player prior to play of the lottery type game. These concealed target symbols can be revealed by removing the concealing layer, for example by removing an opaque film from a ticket medium or in the case of an electronic medium, the image of a target symbol can be displayed to the player upon the selection of a location, for example. It would be readily understood that the target symbols can be exposed independently or collectively depending on the game medium used together with the desire of a player, for example.

In one embodiment of the present invention and with further reference to FIG. 1, the lottery type game has a secondary game area 50 comprising a plurality of arrangements 80 having game symbols 90 therein, wherein in this embodiment the arrangements are a series of columns. Each arrangement, however, may comprise a varying number of rows and/or columns of game symbols or an arrangement may be presented as a random collection or order of game symbols.

In alternative embodiments, the target symbols in the primary game area and/or the game symbols within the one or more arrangements in the secondary game area are covered by a concealing layer.

In another embodiment of the present invention, game symbols or target symbols may be visible to the player, however these symbols may be covered by a transparent layer or an opaque layer with the identity of the symbol below identified thereon. For example, if the target symbols are covered by an opaque scratch off layer, the game symbols may be covered with a transparent scratch off layer. Once matching target and game symbols are identified, the game symbol's transparent layer may be removed to indicate a match with a target symbol. In another embodiment the transparent layer may be provided with a transparent coloured layer. In this embodiment, when the scratch-off layer is removed, the game symbol can be displayed with a different coloured background than the colour of the scratch-off layer, thereby enabling a player to identify which game symbols have been revealed during play.

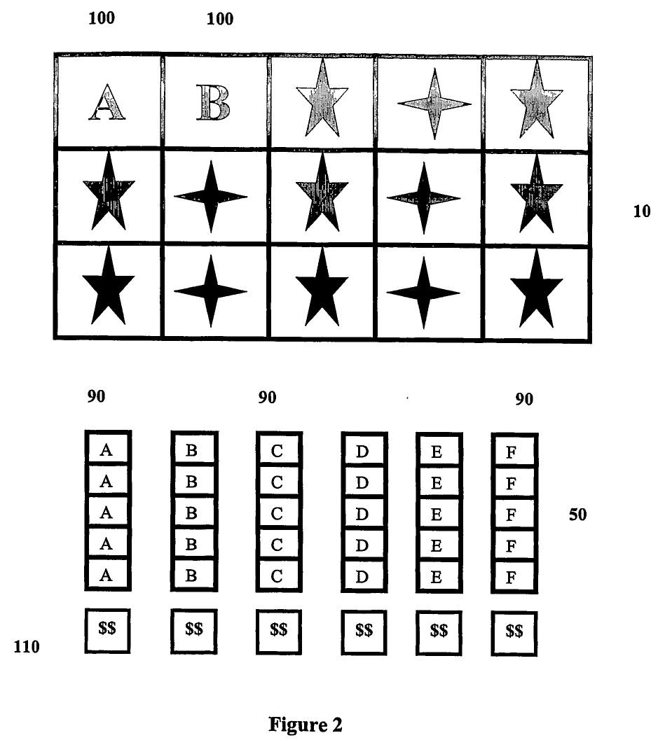

In one embodiment of the present invention and with reference to FIG. 2, once a target symbol 100 is exposed through the removal of the concealing layer, game symbols are compared to the target symbols. Upon matching a target symbol with a game symbol, the game symbol may be marked as being identical through the use of a transparent scratch off layer as mentioned above or any other marking system as would be known by a worker skilled in the relevant art, which can depend on the game medium being used to play the lottery type game. Once all target symbols 100 in the primary game area 10 are exposed and compared to the game symbols 90, a prize may be awarded if all game symbols 90 in a particular arrangement 80 are revealed using target symbols 100. For example, if all game symbols 90 located within the arrangement 80 are matched with target symbols 100 from the primary game area 10 then prize determining means 110, indicating the prize associated with this arrangement is awarded. In an alternate embodiment, a prize may be awarded based on the number of game symbols revealed using target symbols during play of the lottery type game. It would be readily understood to a worker skilled in the art that an arrangement can have any order or type of game symbol therein, however in order to win a prize associated with a particular arrangement, all of the game symbols in the arrangement are to be revealed.

In one embodiment, a bonus prize may be awarded if a certain game symbol is matched with a target symbol. The introduction of the bonus prize may be achieved by having the game symbols printed on a scratch off layer for example, wherein matching of this particular game symbol and the removal of the concealing layer can result in the revealing of the bonus symbol. If a bonus symbol is revealed then a specific prize may be awarded for this action. A bonus symbol may provide an additional action within the lottery type game to be performed by the player. For example a bonus symbol may be a progression symbol that can award a player with the opportunity to reveal an additional game symbol within a particular arrangement of game symbols or provide a player with an opportunity to select an additional game symbol. This revealing action provided by a progression symbol can be performed without the requirement of matching this additional game symbol with a target symbol.

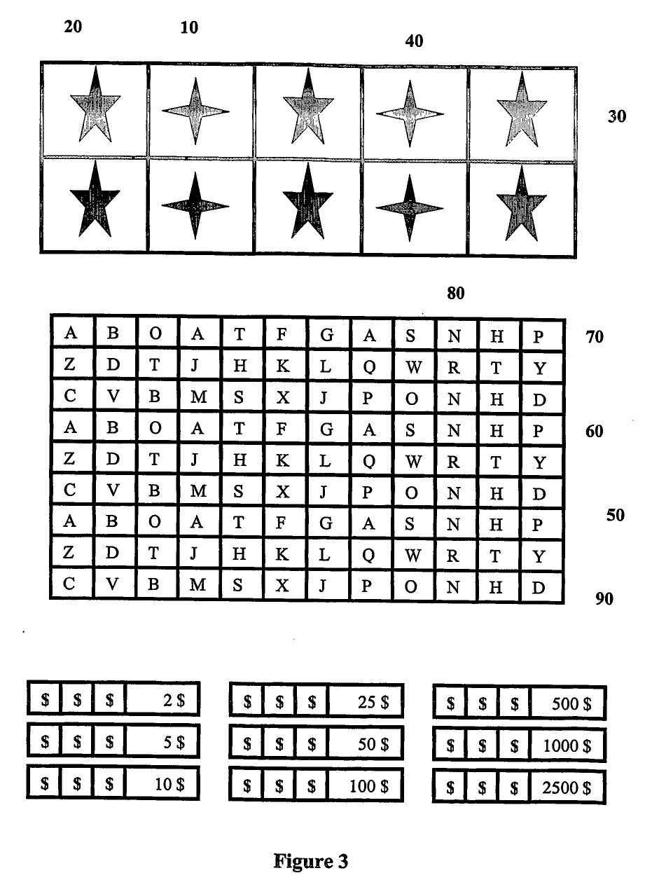

In one embodiment and with reference to FIG. 3, a lottery type game according to the present invention comprises a primary game area 10 including a plurality of locations 20 in a grid formation for example, in the form of a plurality of rows and columns wherein each location has a target symbol associated therewith. A worker skilled in the relevant art would understand that the primary game area may comprise various numbers of rows and columns or the locations may be randomly positioned within the primary game area. In this embodiment, a concealing layer is associated with the target symbols in order to hide them from view of a player prior to play of the lottery type game. These concealed target symbols can be revealed by removing the concealing layer, for example by removing an opaque film from a ticket medium or in the case of an electronic medium, the image of a target symbol can be displayed to the player upon the selection of a location, for example. It would be readily understood that the target symbols can be exposed independently or collectively depending on the game medium used together with the desire of a player, for example.

In one embodiment of the present invention and with further reference to FIG. 3, the lottery type game has a secondary game area 50 comprising a plurality of arrangements having game symbols 90 therein, wherein in this embodiment the arrangements are a series of interconnected rows and columns in a first section and a collection of rows in a further section of the secondary game area. Each arrangement, however, may comprise a varying number of rows and/or columns of game symbols or an arrangement may be presented as a random collection or order of game symbols.

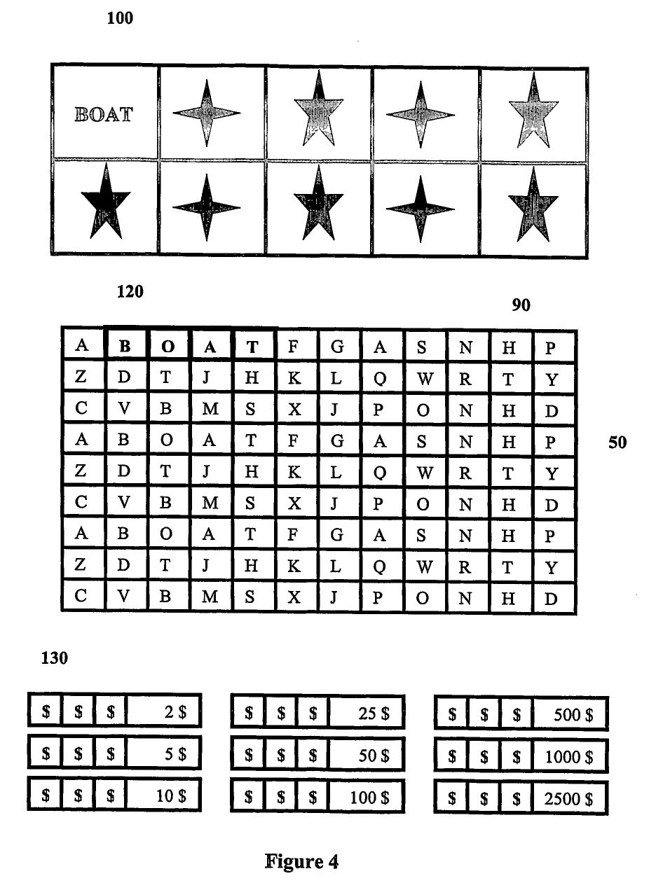

In one embodiment of the present invention and with reference to FIG. 4, a target symbol 100 comprising a word is exposed through the removal of the concealing layer and game symbols 90 within the secondary game area comprising a plurality of letters are compared to the letters forming the revealed target symbol 100. Upon matching the letters of a target symbol with game symbols 90, the game symbols may be marked as being identical, for example, through the removal of a transparent layer or the like as previously defined. For example, the word “BOAT” is revealed as a target symbol and the letters of this target symbol, namely “B”, “O”, “A” and “T” are matched in the secondary game area 50 with four game symbols 90 such that these four game symbols are connected to each other and in the correct sequence. For example, the word “BOAT” can be spelt in the secondary game area using four letters in the correct sequence horizontally, vertically or diagonally. Furthermore, the game symbols can form the target symbol in a forwards or backwards type of configuration, for example. Play of the lottery type game continues until all target symbols have been exposed and compared to the game symbols 90. Upon revealing all target symbols in the primary game area and matching these target symbols with the game symbols in the secondary game area 50, a pre-determined number game symbols 90 may remain unmatched with any target symbols. As such, a prize can be awarded based on the game symbols 90 remaining that can be compared to further arrangements of game symbols having assigned prize determining means associated therewith 110. For example, if the unmatched game symbols can be used to form the word “CAR”, for example, then the prize determining means associated with the arrangement spelling the word “CAR” can determine the prize won by the player. A worker skilled in the relevant art would understand that various prizes can be awarded based on the number of remaining game symbols or the length of the arrangement associated with the prize determining means. The prize determining means can additionally be based on the number of game symbols remaining unmatched using the revealed target symbols. Various bonus prizes can also be awarded based on the remaining unmatched game symbols. A worker skilled in the relevant art would understand various combinations of the remaining game symbols to award prizes without being outside the scope of the present invention.

In one embodiment of the present invention, the gaming medium is an electronic gaming terminal that is capable of enabling the play of a lottery type game according to the present invention. This gaming terminal can includes a display for displaying various game representations, and further includes an input device for receiving player inputs including game play requests. The input device may comprise any type of input arrangement including a keyboard, mouse, roller ball, joystick, lever activated switches or one or more push buttons. The input device may optionally comprise a touch screen that may be integrated with the display. Each gaming terminal may also include an arrangement for receiving payments from a player and an arrangement for making payouts to the player. Payouts may be made using a coin or token dispensing arrangement included in the gaming terminal. Alternatively, or in addition to a coin dispensing arrangement, the gaming terminal may include a printer for printing a ticket showing the player's winnings.

In one embodiment, the gaming terminal comprises a processor for executing game control software that implements the gaming method. In other configurations of the invention a central computer system remote from the gaming terminal can execute some or all of the game control, wherein the gaming terminal becomes a slave in this form of the system. The invention is not limited to any particular processing arrangement, and any processing arrangement that is capable of performing the gaming method described in this disclosure is to be considered an equivalent.

It will be appreciated that, although specific embodiments of the invention have been described herein for purposes of illustration, various modifications may be made without departing from the spirit and scope of the invention. In particular, it is within the scope of the invention to provide a computer program product or program element, or a program storage or memory device such as a solid or fluid transmission medium, magnetic or optical wire, tape or disc, or the like, for storing signals readable by a machine, for controlling the operation of a computer according to the method of the invention and/or to structure its components in accordance with the system of the invention.

Further, each step of the method may be executed on any general computer, such as an IBM System 390, AS/400, PC or the like and pursuant to one or more, or a part of one or more, program elements, modules or objects generated from any programming language, such as C++, Java, P1/1, or the like. And still further, each said step, or a file or object or the like implementing each said step, may be executed by special purpose hardware or a circuit module designed for that purpose.

The embodiments of the invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A method of playing a lottery type game comprising the steps of:
a) providing a game medium including:
i) a primary game area on said game medium, said primary game area having a plurality of target symbols therein, said target symbols being concealed from a player prior to play of the lottery type game;
ii) a secondary game area on said game medium, said secondary game area comprising one or more arrangements of game symbols, a predetermined number of the game symbols corresponding to target symbols; and
iii) a prize determining means on said game medium, said prize determining means enabling a player to determine if the player has won a prize after play of the game;
b) revealing said target symbols;
c) matching and revealing game symbols in said secondary game area using said target symbols;
d) determining if an entire arrangement of game symbols in the secondary game area is matched or revealed using the target symbols; and
e) awarding the player the prize associated with a particular arrangement of game symbols if the entire arrangement of game symbols is matched or revealed.

2. The method according to claim 1, wherein one or more game symbols are a bonus symbol.

3. The method according to claim 2, wherein upon revealing the bonus symbol a player wins a predetermined prize.

4. The method according to claim 2, wherein upon revealing the bonus symbol a player can perform an additional action during play of the game.

5. The method according to claim 4, wherein the additional action is revealing an additional game symbol.

6. The method according to claim 1, wherein a target symbol is a word comprising letters and wherein the step of matching and revealing said game symbols comprises the matching of the letters of the word with individual game symbols representing the letters.

7. The method according to claim 6, wherein the game symbols matching the letters of the word are consecutively positioned within the secondary game area.

8. The method according to claim 6, wherein upon the completion of the matching of the target symbols with game symbols, game symbols remaining unmatched with target symbols are used to form a new word.

9. The method according to claim 8, wherein when the new word matches an arrangement associated with a prize determining means the player wins the corresponding prize.

10. A lottery type game apparatus enabling play of a lottery type game, said apparatus having displayed thereon:
a) a primary game area having a plurality of target symbols therein, said primary game area being concealed from a player prior to play of the lottery type game;
b) a secondary game area comprising one or more arrangements of game symbols, a predetermined number of the game symbols corresponding to target symbols,
c) a prize determining means for determining a prize based on matching target symbols with game symbols, the prize corresponding to an arrangement of game symbols being awarded when an entire arrangement of game symbols in the secondary game area is matched or revealed using the target symbols.

11. The apparatus according to claim 10, wherein the lottery game apparatus is a printed medium.

12. The apparatus according to claim 11, wherein one of the primary game area and the secondary game area are concealed by a scratch off layer, wherein said scratch off layer is selected from the group comprising opaque, transparent, coloured transparent.

13. The apparatus according to claim 10, wherein the lottery game apparatus is an electronic medium.

14. The apparatus according to claim 13, wherein said electronic medium is independent.

15. The apparatus according to claim 14, wherein said electronic medium is a slave in a network, wherein a remote computing device controls actions of said electronic medium.

16. A method of playing a lottery type game comprising the steps of:
a) providing a game medium including:
i) a primary game area on said game medium, said primary game area having a plurality of target symbols therein;
ii) a secondary game area on said game medium, said secondary game area comprising one or more arrangements of game symbols, a predetermined number of the game symbols corresponding to target symbols, at least one of the primary game area and the secondary game area being concealed from a player prior to play of the lottery type game; and
iii) a prize determining means on said game medium, said prize determining means enabling a player to determine if the player has won a prize after play of the lottery type game;
b) revealing target symbols and game symbols that are concealed;
c) matching game symbols in said secondary game area using said target symbols;
d) determining if an entire arrangement of game symbols in the secondary game area is matched or revealed using the target symbols; and
e) awarding the player the prize associated with a particular arrangement of game symbols if the entire arrangement of game symbols is matched or revealed.

17. The method according to claim 16, wherein one or more game symbols are a bonus symbol.

18. The method according to claim 17, wherein upon revealing the bonus symbol a player wins a predetermined prize.

19. The method according to claim 17, wherein upon revealing the bonus symbol a player can perform an additional action during play of the game.

20. The method according to claim 19, wherein the additional action is revealing an additional game symbol.

21. The method according to claim 16, wherein a target symbol is a word comprising letters and wherein the step of matching and revealing said game symbols comprises the matching of the letters of the word with individual game symbols representing the letters.

22. The method according to claim 21, wherein the game symbols matching the letters of the word are consecutively positioned within the secondary game area.

23. The method according to claim 21, wherein upon the completion of the matching of the target symbols with game symbols, game symbols remaining unmatched with target symbols are used to form a new word.

24. The method according to claim 23, wherein when the new word matches an arrangement associated with a prize determining means the player wins the corresponding prize.

25. A computer program product comprising a computer readable medium having a computer program recorded thereon for performing a method of playing a lottery type game, said method comprising the steps of:
a) providing a game medium including:
i) a primary game area on said game medium, said primary game area having a plurality of target symbols therein, said target symbols being concealed from a player prior to play of the lottery type game;
ii) a secondary game area on said game medium, said secondary game area comprising one or more arrangements of game symbols, a predetermined number of the game symbols corresponding to target symbols; and
iii) a prize determining means on said game medium, said prize determining means enabling a player to determine if the player has won a prize after play of the game;
b) revealing said target symbols;
c) matching and revealing game symbols in said secondary game area using said target symbols;
d) determining if an entire arrangement of game symbols in the secondary game area is matched or revealed using the target symbols; and
e) awarding the player the prize associated with a particular arrangement of game symbols if the entire arrangement of game symbols is matched or revealed.
